(19) United States
(12) Patent Application Publication
(10) Pub. No.: US 2006/0116881 A1
(43) Pub. Date: Jun. 1, 2006

(54) Portable-type communication terminal device, contents output method, distribution server and method thereof, and contents supply system and supply method thereof

(75) Inventors: Yohei Umezawa, Tokyo (JP); Yoshio Nitta, Tokyo (JP); Katsuhiko Okamoto, Tokyo (JP); Hiroaki Hattori, Tokyo (JP); Minako Miyamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/290,416

(22) Filed: Dec. 1, 2005

(30) Foreign Application Priority Data
Dec. 1, 2004 (JP) 2004-348502

(51) Int. Cl. G10L 21/00

(52) U.S. Cl. 704/270

(57) ABSTRACT

Portable-type communication terminal device easy to use by a user is provided. Determination unit determines, based on whether electronic mail received by a communication unit contains contents identification information, whether the electronic mail is contents electronic mail. When determining that the electronic mail is contents electronic mail, the determination unit outputs an activation signal to a speech synthesis unit and an image processing unit. Upon receiving the activation signal, the speech synthesis unit executes speech synthesis based on text contained in the electronic mail to output voice through a speaker. Upon receiving the activation signal, the image processing unit executes image processing based on face marks contained in the text of the electronic mail to change a face expression of a face image displayed by the image display unit according to voice output by a voice output unit.

### BACKGROUNDS OF THE INVENTION

1. Field of the Invention

The present invention relates to a portable-type communication terminal device, a distribution server, a contents supply system, a contents output method, a contents distribution method and a contents supply method.

2. Description of the Related Art

Information processing devices capable of receiving electronic mail (e.g. mobile phone) have been widely used.

Disclosed in Japanese Patent Laying-Open (Kokai) No. 2000-123191 and Japanese Patent Laying-Open (Kokai) No. 2002-288686 are information processing devices which, upon receiving a piece of electronic mail, execute speech synthesis based on text contained in the electronic mail to output voice and change representation of a face in synchronization with the voice output.

The information processing devices recited in Japanese Patent Laying-Open (Kokai) No. 2000-123191 and Japanese Patent Laying-Open (Kokai) No. 2002-288686, when receiving a piece of electronic mail, read text of the electronic mail to change representation of a face without fail. Therefore, there arises a problem that these information processing devices output voice even when receiving a piece of electronic mail which requires no voice output.

This problem can be solved, for example, by setting an information processing devices by a user to refrain from reading text of electronic mail. In this case, however, when the information processing device prepares electronic mail requiring voice output, a user needs to do laborious work of setting the information processing device to read text of the electronic mail.

### SUMMARY OF THE INVENTION

An object of the present invention is to provide a portable-type communication terminal device, a distribution server, a contents supply system, a contents output method, a contents distribution method and a contents supply method which are easy to use by a user.

According to one aspect of the invention, a portable-type communication terminal device capable of receiving electronic mail containing contents for speech synthesis which are described in text format and contents identification information indicative of the contents, comprises a reception unit which receives electronic mail, and a voice output unit which executes speech synthesis, when said contents identification information is contained in received electronic mail, based on text describing contents of said electronic mail to output voice.

According to another aspect of the invention, a contents output method executed by a portable-type communication terminal device capable of receiving electronic mail containing contents for speech synthesis which are described in text format and contents identification information indicative of the contents, comprising the steps of a reception step of receiving electronic mail, a determination step of determining whether said received electronic mail contains said contents identification information or not, and a voice output step of, when determination is made that said electronic mail contains said contents identification information, executing speech synthesis based on text describing contents of said electronic mail to output voice.

According to the above-described invention, electronic mail containing contents identification information is automatically read. Therefore, even if a user fails to set whether a portable-type communication terminal device should read text of electronic mail or not, contents indicated by electronic mail containing contents identification information are automatically output as voice.

In the preferred construction, the portable-type communication terminal device further comprises a display unit which displays a picture whose form changes with voice output by said voice output unit.

According to the present invention, because a picture changes according to contents, the contents can be effectively represented.

According to another aspect of the invention, a distribution server which distributes, to a portable-type communication terminal device capable of receiving electronic mail containing contents for speech synthesis which are described in text format and contents identification information indicative of the contents, said contents electronic mail, comprises a storage unit which stores an electronic mail address of said portable-type communication terminal device having a reception unit which receives electronic mail and a voice output unit which executes speech synthesis, when said contents identification information is contained in received electronic mail, based on text describing contents of said electronic mail to output voice, and a transmission unit which transmits contents electronic mail containing contents for speech synthesis which are described in text format and contents identification information indicative of the contents to an electronic mail address stored in said storage unit.

According to another aspect of the invention, a contents distribution method in a distribution server which distributes, to a portable-type communication terminal device capable of receiving electronic mail containing contents for speech synthesis which are described in text format and contents identification information indicative of the contents, said contents electronic mail, comprising the steps of a storing step of storing an electronic mail address of said portable-type communication terminal device which receives electronic mail, determines whether said received electronic mail contains said contents identification information and when determining that said contents identification information is contained in said electronic mail, executes speech synthesis based on text describing contents of said electronic mail to output voice, and a transmission step of transmitting contents electronic mail containing contents for speech synthesis which are described in text format and contents identification information indicative of the contents to said stored electronic mail address.

According to the present invention, contents electronic mail containing contents described in text format and contents identification information is transmitted. Since contents electronic mail contains contents identification information, a portable-type communication terminal device is allowed to determine whether received electronic mail is contents electronic mail or not based on whether contents identification information exists or not.

In another preferred construction, the storage unit stores a plurality of electronic mail addresses of said portable-type communication terminal device, and said transmission unit simultaneously transmits said contents electronic mail to said plurality of electronic mail addresses.

According to the present invention, common contents electronic mail can be simultaneously broadcast to a plurality of portable-type communication terminal devices.

In another preferred construction, the distribution server further comprises a reception unit which receives a contents request output by said portable-type communication terminal device and an electronic mail address of the device, wherein said storage unit stores an electronic mail address received by said reception unit, and said transmission unit, when said reception unit receives said contents request, transmits said contents electronic mail to an electronic mail address of a portable-type communication terminal device which has output the contents request.

According to the present invention, contents electronic mail can be transmitted on demand.

According to another aspect of the invention, a contents supply method executed by a contents supply system including a distribution server and a portable-type communication terminal device which receives electronic mail distributed by said distribution server, comprising the steps of a storing step by said distribution server to store an electronic mail address of said portable-type communication terminal device, a transmission step of said distribution server to transmit contents electronic mail containing contents for speech synthesis which are described in text format and contents identification information indicative of the contents to said stored electronic mail address, a reception step of said portable-type communication terminal device to receive electronic mail, a determination step of said portable-type communication terminal device to determine whether said received electronic mail contains said contents identification information or not, and a voice output step of said portable-type communication terminal device to execute speech synthesis, when said contents identification information is contained in said electronic mail, based on text describing contents of said electronic mail to output voice.

According to the present invention, a portable-type communication terminal device which automatically reads electronic mail containing contents identification information can be provided with contents supply service.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a contents supply system according to one embodiment of the present invention;

FIG. 2 is a flow chart for use in explaining operation of a distribution server according to one embodiment of the present invention;

FIG. 3 is a flow chart for use in explaining operation of a mobile phone according to one embodiment of the present invention;

FIG. 4 is a flow chart for use in explaining operation of the distribution server according to one embodiment of the present invention; and

FIG. 5 is a flow chart for use in explaining operation of the distribution server according to one embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

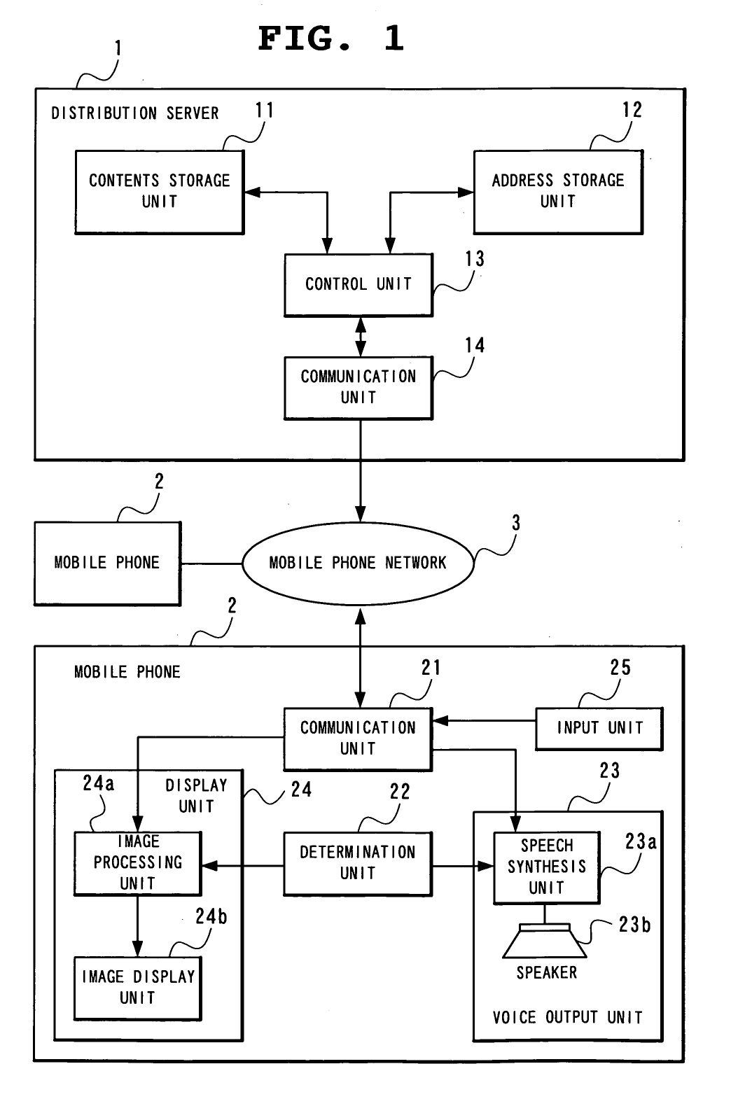

FIG. 1 is a block diagram showing a contents supply system according to one embodiment of the present invention.

In FIG. 1, the present contents supply system includes a distribution server 1 and a mobile phone 2. A plurality of mobile phones 2 may exist. The distribution server 1 and the mobile phone 2 communicate with each other through a mobile phone network 3.

The distribution server 1 includes a contents storage unit 11, an address storage unit 12, a control unit 13 and a communication unit 14. The mobile phone 2 includes a communication unit 21, a determination unit 22, a voice output unit 23, a display unit 24 and an input unit 25. The voice output unit 23 includes a speech synthesis unit 23a and a speaker 23b. The display unit 24 includes an image processing unit 24a and an image display unit 24b.

The distribution server 1 is managed, for example, by a contents provider which provides virtual broadcasting (contents distribution) service.

The contents storage unit 11 stores contents (e.g. program) for executing speech synthesis described in text format. The contents desirably contain a display control symbol (e.g. a face mark or a symbol indicative of a face which is described in text format). In addition, the contents storage unit 11 desirably stores a plurality of kinds of contents.

The address storage unit 12 stores an electronic mail address of a distribution destination of the contents stored in the contents storage unit 11. When the contents storage unit 11 stores a plurality of kinds of contents, the address storage unit 12 stores, for each content, an electronic mail address of a distribution destination of the content. An electronic mail address of the distribution destination is, for example, an electronic mail address of the mobile phone 2.

The control unit 13 controls the distribution server 1.

The control unit 13 generates, for example, contents electronic mail formed of contents stored in the contents storage unit 11 with contents identification information indicative of the contents attached. Contents electronic mail is electronic mail. Contents identification information is, for example, a specific character string (e.g. hoso660785) which is attached to a subject (subject name) of contents electronic mail. Contents identification information is not limited to the above-described and can be appropriately changed. Contents identification information may be attached to main text of contents electronic mail.

For the control unit 13 to discriminate contents electronic mail from ordinary mail, contents identification information may better include a string of random numeric characters, letters and symbols which are unlikely to be used in a subject name of ordinary mail or mail main text. In the above-described “hoso660785”, for example, “660785” corresponds to such a string. With a string of random numeric characters, letters and symbols having a certain length, it is extremely unlikely that they will coincide with a subject name of ordinary mail or main text by chance.

The control unit 13 reads an electronic mail address of a distribution destination of contents electronic mail from the address storage unit 12 to output the contents electronic mail and the electronic mail address of the distribution destination to the communication unit 14.

Upon receiving the contents electronic mail and the electronic mail address of the distribution destination output from the control unit 13, the communication unit 14 transmits the contents electronic mail to the electronic mail address of the distribution destination.

When the distribution server 1 simultaneously broadcasts contents electronic mail to a plurality of distribution destinations (e.g. a plurality of mobile phones 2), the control unit 13 reads each electronic mail address of the plurality of distribution destinations of the contents electronic mail from the address storage unit 12 to output the contents electronic mail and the electronic mail addresses of the plurality of distribution destinations to the communication unit 14. The communication unit 14 simultaneously transmits the contents electronic mail to the electronic mail addresses of the plurality of distribution destinations.

When the distribution server 1 distributes contents electronic mail on demand, upon receiving a contents request and an electronic mail address from a distribution originator (e.g. the mobile phone 2) through the communication unit 14, the control unit 13 stores the electronic mail address in the address storage unit 12. Thereafter, the control unit 13 generates contents electronic mail containing the requested content to output the contents electronic mail and the electronic mail address to the communication unit 14. The communication unit 14 transmits the contents electronic mail to the electronic mail address of the distribution destination.

In a case where the distribution server 1 executes push-type distribution of contents electronic mail, when a predetermined condition is satisfied (e.g. the mobile phone 2 exists at a predetermined position or comes closer to the same), the control unit 13 automatically reads an electronic mail address of a distribution destination (e.g. the mobile phone 2) from the address storage unit 12 and generates contents electronic mail. Thereafter, the control unit 13 outputs the electronic mail address and the contents electronic mail to the communication unit 14. The communication unit 14 transmits the contents electronic mail to the electronic mail address.

The mobile phone 2 is one example of a portable-type communication terminal device. The portable-type communication terminal device is not limited to a mobile phone and can be appropriately changed. The mobile phone 2 is allowed to receive contents electronic mail transmitted by the distribution server 1.

The communication unit 21 receives electronic mail. The communication unit 21 outputs the received electronic mail to the determination unit 22, the voice output unit 23 and the display unit 24.

The determination unit 22 determines whether the electronic mail received by the communication unit 21 contains contents identification information or not. In other words, the determination unit 22 determines whether the electronic mail received by the communication unit 21 is contents electronic mail or not.

When determining that the electronic mail received by the communication unit 21 is contents electronic mail, the determination unit 22 outputs an activation signal to the voice output unit 23 (more specifically, the speech synthesis unit 23a) and the display unit 24 (more specifically, the image processing unit 24a).

Upon accepting the activation signal from the determination unit 22, the voice output unit 23 executes speech synthesis based on text which describes contents of the electronic mail output from the communication unit 21 to output the contents contained in the electronic mail as voice.

More specifically, the speech synthesis unit 23a, when accepting the activation signal from the determination unit 22, executes speech synthesis based on text (contents) which describes contents of the electronic mail output from the communication unit 21 to output voice (the contents) obtained by the speech synthesis through the speaker 23b.

Upon accepting the activation signal from the determination unit 22, the display unit 24 displays a picture whose form changes with voice (contents) output by the voice output unit 23. The display unit 24 displays, for example, a face image in which a face expression changes according to voice output by the voice output unit 23. The picture displayed by the display unit 24 is not limited to a face image and can be appropriately modified.

More specifically, upon accepting the activation signal from the determination unit 22, the image processing unit 24a executes image processing based on a display control symbol (e.g. face mark) contained in text of electronic mail output from the communication unit 21 to change a face expression of a face image displayed by the image display unit 24b according to voice output by the voice output unit 23. The image processing unit 24a displays the text of the electronic mail output from the communication unit 21 on the image display unit 24b.

The input unit 25 accepts user's input.

Next, operation will be described.

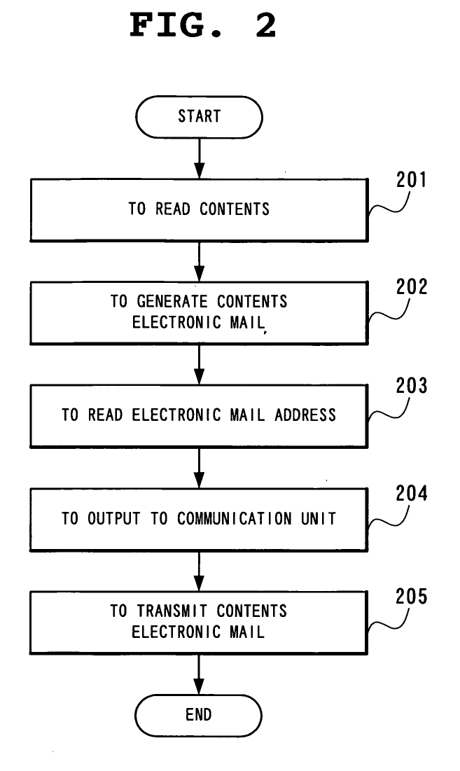

FIG. 2 is a flow chart for use in explaining operation of simultaneously broadcasting contents electronic mail to a plurality of distribution destinations (e.g. the plurality of mobile phones 2) by the distribution server 1. In the following, description will be made of the operation of broadcasting contents electronic mail to a plurality of distribution destinations by the distribution server 1.

At Step 201, the control unit 13 reads contents to be distributed from the contents storage unit 11. When Step 201 is completed, the control unit 13 executes Step 202.

At Step 202, the control unit 13 generates contents electronic mail containing the contents to be distributed. At this time, the control unit 13 attaches contents identification information to a subject (subject name) of the contents electronic mail. The control unit 13 executes Step 203 when Step 202 is completed.

At Step 203, the control unit 13 reads each electronic mail address of the plurality of distribution destinations of the contents to be distributed from the address storage unit 12. The control unit 13 executes Step 204 when Step 203 is completed.

At Step 204, the control unit 13 outputs the generated contents electronic mail and the read electronic mail addresses of the plurality of distribution destinations to the communication unit 14. Upon receiving the contents electronic mail and the electronic mail addresses of the plurality of distribution destinations from the control unit 13, the communication unit 14 executes Step 205.

At Step 205, the communication unit 14 simultaneously transmits the contents electronic mail to the electronic mail addresses of the plurality of distribution destinations.

Next, description will be made of operation of storing an electronic mail address of a distribution destination in the address storage unit 12.

When the user of the mobile phone 2 operates the input unit 25 such that the mobile phone 2 accesses a site of a contents provider which manages the distribution server 1, the communication unit 21 accesses the site.

Site of the contents provider may be a Web server (not shown) different from the distribution server 1 or may be the distribution server 1.

In a case where the site of the contents provider is a Web server different from the distribution server 1, the Web server provides the mobile phone 2 which has made the access with a list of contents. The display unit 24 of the mobile phone 2 displays the list.

The user of the mobile phone 2 operates the input unit 25 to select contents whose distribution is desired from the list. The communication unit 21 notifies the Web server of the selected contents.

The Web server gives the distribution server 1 the notification.

The control unit 13 of the distribution server 1 adds the electronic mail address of the mobile phone 2 as a distribution destination of the selected contents to the address storage unit 12.

Thereafter, the distribution server 1 simultaneously distributes the contents electronic mail containing the selected contents to a plurality of distribution destinations including the mobile phone 2.

On the other hand, in a case where the site of the contents provider is the distribution server 1, the control unit 13 of the distribution server 1 provides the accessing mobile phone 2 with a list of the contents. The display unit 24 of the mobile phone 2 displays the list.

The user of the mobile phone 2 operates the input unit 25 to select contents whose distribution is desired from the list. The communication unit 21 notifies the distribution server 1 of the selected contents.

The control unit 13 of the distribution server 1 adds the electronic mail address of the mobile phone 2 as a distribution destination of the selected contents to the address storage unit 12.

Thereafter, the distribution server 1 simultaneously distributes the contents electronic mail containing the selected contents to a plurality of distribution destinations including the mobile phone 2.

Upon accepting a contents stop request from a distribution destination, the control unit 13 of the distribution server 1 deletes an electronic mail address of the distribution destination from the address storage unit 12. As a result, the distribution server 1 stops distribution of the contents electronic mail to the distribution destination.

It is desirable that the distribution server 1 should transmit one contents as a plurality of pieces of divisional contents electronic mail. In this case, it is desirable that the distribution server 1 should transmit contents electronic mail periodically (e.g. every ten minutes), for example.

When one content is divided into a plurality of pieces of contents electronic mail, a capacity of one piece of contents electronic mail can be made smaller. Therefore, a possibility that the mobile phone 2 will refuse reception of contents electronic mail due to reception capacity over can be reduced.

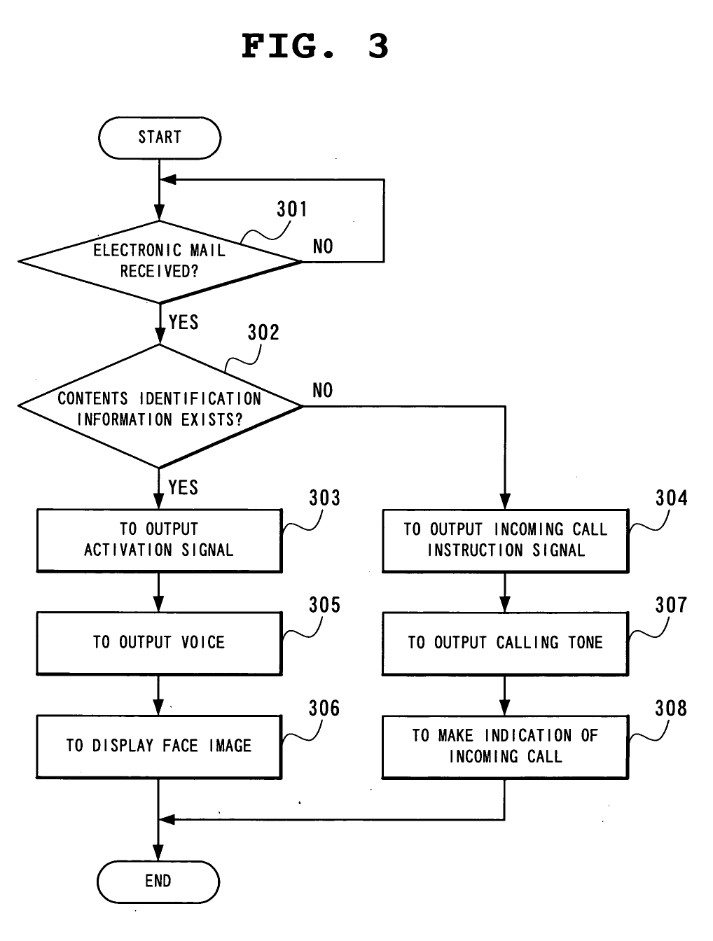

FIG. 3 is a flow chart for use in explaining operation of the mobile phone 2. In the following, description will be made of the operation of the mobile phone 2 with reference to FIG. 3.

At Step 301, determination is made whether the communication unit 21 receives electronic mail or not. When the electronic mail is not received, again execute Step 301. On the other hand, upon receiving electronic mail, the communication unit 21 outputs the received electronic mail to the determination unit 22, the voice output unit 23 and the display unit 24. The determination unit 22 executes Step 302 upon receiving electronic mail from the communication unit 21.

At Step 302, the determination unit 22 determines whether contents identification information is contained in the electronic mail received by the communication unit 21. In other words, the determination unit 22 determines whether the electronic mail received by the communication unit 21 is contents electronic mail or not.

When determining that the electronic mail received by the communication unit 21 is contents electronic mail, the determination unit 22 executes Step 303 and when determining that the electronic mail received by the communication unit 21 is not contents electronic mail, executes Step 304.

At Step 303, the determination unit 22 outputs an activation signal to the speech synthesis unit 23a and the image processing unit 24a. Upon accepting the activation signal, the speech synthesis unit 23a executes Step 305. The image processing unit 24a executes Step 306 upon receiving the activation signal.

At Step 305, the speech synthesis unit 23a executes speech synthesis based on text (contents) which describes the contents of the electronic mail output from the communication unit 21 to output voice (contents) obtained by the speech synthesis through the speaker 23b.

Voice may be set to be synthesized a plurality of kinds such as men's voice, women's voice and children's voice by the speech synthesis unit 23a and selected by a user or a tag which designates a kind of voice may be contained in contents and recognized by the speech synthesis unit 23a to output voice, that is, voice may not be selected by a user (default setting).

At Step 306, the image processing unit 24a executes image processing based on a display control symbol (e.g. face mark) which text of the electronic mail output from the communication unit 21 contains to change a face expression of a face image displayed by the image display unit 24b according to voice output by the voice output unit 23. The image processing unit 24a displays the text of the electronic mail output from the communication unit 21 on the image display unit 24b.

As a kind, a face image may be, for example, an image of a human face or a face image of a character. In addition, a kind of face image may be selected by a user or may be automatically selected (e.g. default selection) by the speech synthesis unit 23a.

On the other hand, at Step 304, the determination unit 22 outputs an incoming call instruction signal to the speech synthesis unit 23a and the image processing unit 24a. Upon accepting the incoming call instruction signal, the speech synthesis unit 23a executes Step 307. The image processing unit 24a executes Step 308 upon accepting the incoming call instruction signal.

At Step 307, the speech synthesis unit 23a outputs a calling tone through the speaker 23b.

At Step 308, the image processing unit 24a makes indication of incoming call on the image display unit 24b.

When contents electronic mail is transmitted successively, the mobile phone 2 is allowed to output contents without interruption.

When a capacity of content is large, the content is divided and divisional contents are distributed at a time interval. Distributing the contents a little before the contents distributed by preceding mail ends to have a time margin prevents the terminal (mobile phone 2) from interrupting output.

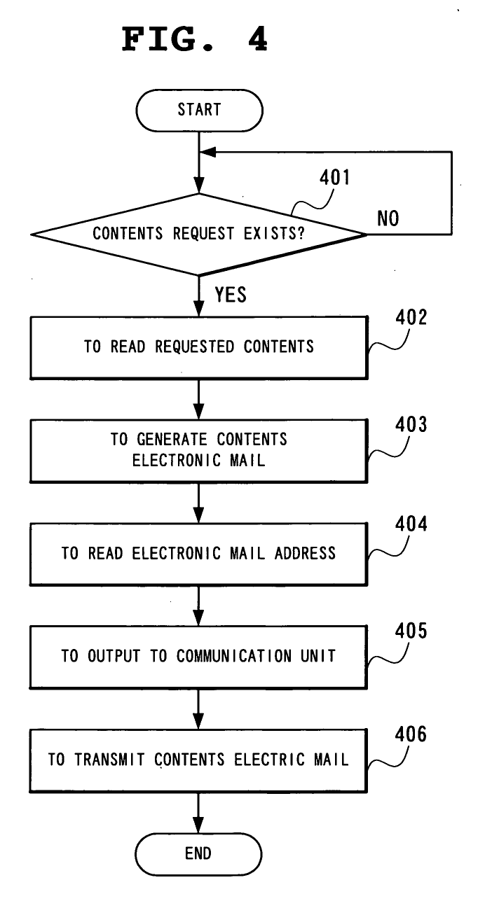

FIG. 4 is a flow chart for use in explaining operation of transmitting contents electronic mail to a distribution destination on demand by the distribution server 1. In the following, description will be made of the operation of transmitting contents electronic mail to a distribution destination on demand by the distribution server 1.

In transmission on demand, contents electronic mail is not always broadcast simultaneously. In transmission on demand, when a contents request is made, contents electronic mail is individually distributed to a distribution destination (e.g. the mobile phone 2) which has requested contents. In addition, in transmission on demand, when the contents ends, distribution of the contents electronic mail is automatically stopped.

At Step 401, the control unit 13 determines whether the communication unit 14 accepts the contents request output by the mobile phone 2 and its electronic mail address.

When the contents request and its electronic mail address are not accepted, the control unit 13 again executes Step 401. On the other hand, when the contents request and its electronic mail address are accepted, the control unit 13 executes Step 402.

At Step 402, the control unit 13 reads the requested contents from the contents storage unit 11. The control unit 13 executes Step 403 when Step 402 is completed.

At Step 403, the control unit 13 generates content electronic mail containing the read contents. At this time, the control unit 13 attaches contents identification information to a subject (subject name) of the contents electronic mail. The control unit 13 executes Step 404 when Step 403 is completed.

At Step 404, the control unit 13 stores the accepted electronic mail address in the address storage unit 12 and thereafter reads the stored electronic mail address. The control unit 13 executes Step 405 when Step 404 is completed.

At Step 405, the control unit 13 outputs the generated contents electronic mail and its electronic mail address to the communication unit 14. The communication unit 14 executes Step 406 upon receiving the contents electronic mail and the electronic mail address from the control unit 13.

At Step 406, the communication unit 14 transmits the contents electronic mail to the electronic mail address.

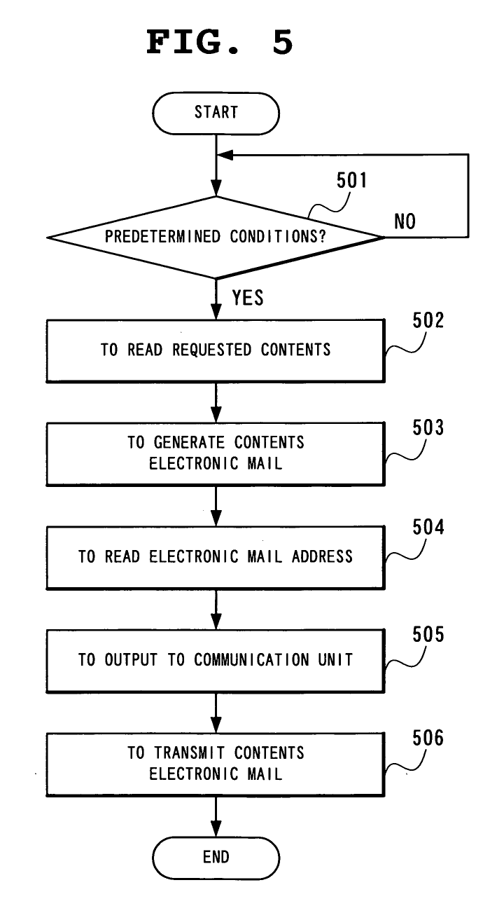

FIG. 5 is a flow chart for use in explaining operation of executing push-type transmission of contents electronic mail to a distribution destination by the distribution server 1. In the following, description will be made of the operation of executing push-type transmission of contents electronic mail to a distribution destination by the distribution server 1.

In push-type distribution, contents electronic mail is distributed not triggered by a contents request from a user. In push-type distribution, contents electronic mail is automatically distributed from the distribution server 1 to the distribution destination (e.g. the mobile phone 2) on such a condition as position information (e.g. information that the mobile phone 2 exists in a predetermined region or comes closer to the same).

In push-type distribution, however, registration for service (registration of electronic mail address and registration of requested contents) should be made at a contents provider by a user in advance.

In the present embodiment, assume that the address storage unit 12 stores identification information of a distribution destination (e.g. the mobile phone 2) to which push-type distribution is desired in correlation with an electronic mail address of the distribution destination and a requested contents name of the distribution destination.

At Step 501, the control unit 13 determines whether a predetermined condition for executing push-type distribution is satisfied or not.

In the present embodiment, the predetermined condition is assumed to be that the mobile phone 2 to which push-type distribution is desired exists in a predetermined region. In the present embodiment, the mobile phone 2 notifies its own current position together with its own identification information to the distribution server 1. This notification may be periodically transmitted by radio or executed by infrared communication based on user's operation or made by the RFID technique.

In a case where the mobile phone 2 has a function of transmitting and receiving to/from a radio LAN or a function of communicating with an RFID reader, and a radio LAN post or an RFID reader communicable with the distribution server 1 is disposed at a predetermined place, the distribution server 1 may execute push-type distribution in the following manner.

The distribution server 1 transmits contents electronic mail to the mobile phone 2 on a predetermined condition that the mobile phone 2 is allowed transmission with a radio LAN post or an RFID reader. In this case, the mobile phone 2 needs not have a position information transmitting function.

When the mobile phone 2 fails to exist in the predetermined region, the control unit 13 again executes Step 501. On the other hand, when the mobile phone 2 exists in the predetermined region, the control unit 13 executes Step 502.

At Step 502, the control unit 13 reads a contents name correlated with the identification information notified by the mobile phone 2 from the address storage unit 12 to read contents corresponding to the read contents name from the contents storage unit 11. The control unit 13 executes Step 503 when Step 502 is completed.

At Step 503, the control unit 13 generates contents electronic mail containing the read contents. At this time, the control unit 13 attaches contents identification information to a subject (subject name) of the contents electronic mail. The control unit 13 executes Step 504 when Step 503 is completed.

At Step 504, the control unit 13 reads an electronic mail address correlated with the identification information notified by the mobile phone 2 from the address storage unit 12. The control unit 13 executes Step 505 when Step 504 is completed.

At Step 505, the control unit 13 outputs the generated contents electronic mail and its electronic mail address to the communication unit 14. The communication unit 14 executes Step 506 upon receiving the contents electronic mail and the electronic mail address from the control unit 13.

At Step 506, the communication unit 14 transmits the contents electronic mail to the electronic mail address.

The present embodiment produces the following effects.

Virtual broadcasting service using a mobile phone can be realized.

For example, virtual radio broadcasting can be realized by using contents electronic mail. In other words, using a mobile phone which a user brings daily, broadcasting service can be realized. At present, those who bring radios are less than those who bring mobile phones. Under these circumstances, realizing broadcasting service by using a mobile phone is effective. This enables users of this service to kill their time or change atmosphere by using their own mobile phones.

Streaming service which provides a mobile phone with contents in a broadcasting manner is currently known, which service is provided only to a mobile phone mounted with a high-speed data communication unit. Therefore, a mobile phone is not allowed to receive the streaming service unless it is mounted with a high-speed data communication unit.

On the contrary, the present embodiment allows even a mobile phone having no high-speed data communication unit mounted to receive provision of contents like broadcasting.

In the present embodiment, the determination unit 22 determines whether electronic mail received by the communication unit 21 contains contents identification information or not. When the determination unit 22 determines that the received electronic mail contains contents identification information, the voice output unit 23 executes speech synthesis based on text which describes contents of the electronic mail to output voice. As a result, even without user's setting whether the mobile phone 2 is to read text of electronic mail or not, contents represented in electronic mail containing contents identification information are automatically output as voice.

In addition, according to the present embodiment, the display unit 24 displays a picture (face image) whose form (face expression) changes with voice output by the voice output unit 23. In this case, contents can be effectively expressed.

Using a picture changing function together with other functions enables provision of virtual television service. Use of a human face image as a picture allows a face expression to change with voice of the above-described virtual radio service. Therefore, as compared with service only with voice, more humane and attractive service can be provided.

Moreover, in the present embodiment, the communication unit 14 transmits contents electronic mail containing contents described in text format and contents identification information to an electronic mail address stored in the address storage unit 12. In this case, since the contents electronic mail contains contents identification information, the mobile phone 2 is allowed to determine whether received electronic mail is contents electronic mail or not based on whether contents identification information exists or not.

Furthermore, the address storage unit 12 stores a plurality of electronic mail addresses of the mobile phone 2. The communication unit 14 simultaneously transmits contents electronic mail to the plurality of electronic mail addresses. In this case, common contents electronic mail can be simultaneously broadcast to a plurality of portable-type communication terminal devices.

In a case of simultaneous broadcasting type service, as long as information (contents) is transmitted from a contents provider all the time, a user is allowed to use the service by as if tuning the provider. Using real-time information such as news and latest results of sports as contents makes the service effective.

In addition, in the present embodiment, a contents request output from the mobile phone 2 and its electronic mail address are received by the communication unit 14. The address storage unit 12 stores the accepted electronic mail address. When the contents request is accepted, the communication unit 14 transmits contents electronic mail to the electronic mail address of the mobile phone 2 which has output the contents request. In this case, the contents electronic mail can be transmitted on demand.

In a case of on-demand type service, contents are distributed in response to a user's request. In on-demand type service, when the distribution server 1 prepares various kinds of contents such as quiz and those related to hobby, users are allowed to use contents meeting their tastes whenever they like.

In addition, in the present embodiment, the communication unit 14 transmits contents electronic mail to an electronic mail address stored by the address storage unit 12 in a push-type manner.

Push-type service is applicable to service of operating conventional push-type advertisement mail more effectively or audio guidance service in museum or the like.

According the contents supply system of the present embodiment, contents supply service can be provided to a mobile phone which automatically reads electronic mail containing contents identification information.

The respective functions of the above-described distribution server and the portable-type communication terminal device (mobile phone) according to the present embodiment can be realized not only by hardware but also as software by loading a program as a computer program having the respective functions (a distribution program of the distribution server and a contents output program of the portable-type communication terminal device) into a memory of computer processing devices of the distribution server and the portable-type communication terminal device and executing the same. These programs are stored in a recording medium such as a magnetic disk, a semiconductor memory or the like and loaded into a computer processing device from the recording medium to control operation of the computer processing device, thereby realizing the above-described respective functions.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A portable-type communication terminal device capable of receiving electronic mail containing contents for speech synthesis which are described in text format and contents identification information indicative of the contents, comprising:
a reception unit which receives electronic mail; and
a voice output unit which executes speech synthesis, when said contents identification information is contained in received electronic mail, based on text describing contents of said electronic mail to output voice.

2. The portable-type communication terminal device as set forth in claim 1, further comprising
a determination unit which determines whether electronic mail received by said reception unit contains said contents identification information or not, wherein
when said determination unit determines that said electronic mail contains said contents identification information, said voice output unit executes speech synthesis based on said text to output voice.

3. The portable-type communication terminal device as set forth in claim 1, further comprising
a display unit which displays a picture whose form changes with voice output by said voice output unit.

4. A distribution server which distributes, to a portable-type communication terminal device capable of receiving electronic mail containing contents for speech synthesis which are described in text format and contents identification information indicative of the contents, said contents electronic mail, comprising:
a storage unit which stores an electronic mail address of said portable-type communication terminal device having a reception unit which receives electronic mail and a voice output unit which executes speech synthesis, when said contents identification information is contained in received electronic mail, based on text describing contents of said electronic mail to output voice; and
a transmission unit which transmits contents electronic mail containing contents for speech synthesis which are described in text format and contents identification information indicative of the contents to an electronic mail address stored in said storage unit.

5. The distribution server as set forth in claim 4, wherein
said storage unit stores a plurality of electronic mail addresses of said portable-type communication terminal device, and
said transmission unit simultaneously transmits said contents electronic mail to said plurality of electronic mail addresses.

6. The distribution server as set forth in claim 4, further comprising
a reception unit which receives a contents request output by said portable-type communication terminal device and an electronic mail address of the device, wherein
said storage unit stores an electronic mail address received by said reception unit, and
said transmission unit, when said reception unit receives said contents request, transmits said contents electronic mail to an electronic mail address of a portable-type communication terminal device which has output the contents request.

7. The distribution server as set forth in claim 4, wherein
said transmission unit transmits said contents electronic mail to an electronic mail address stored in said storage unit in a push-type manner.

8. The distribution server as set forth in claim 4, wherein
said contents identification information is information which is unlikely to be used in a subject name of ordinary mail and main text of ordinary mail.

9. A contents supply system including a portable-type communication terminal device capable of receiving electronic mail containing contents for speech synthesis which are described in text format and contents identification information indicative of the contents and a distribution server which distributes said contents electronic mail to said portable-type communication terminal device, wherein
said portable-type communication terminal device includes
a reception unit which receives electronic mail,
a determination unit which determines whether electronic mail received by said reception unit contains said contents identification information or not, and
a voice output unit which executes speech synthesis, when said determination unit determines that said contents identification information is contained in said electronic mail, based on text describing contents of said electronic mail to output voice, and
said distribution server includes
a storage unit which stores an electronic mail address of a portable-type communication terminal device, and
a transmission unit which transmits contents electronic mail containing contents for speech synthesis which are described in text format and contents identification information indicative of the contents to an electronic mail address stored in said storage unit.

10. The contents supply system as set forth in claim 9, wherein
said portable-type communication terminal device further comprises
a display unit which displays a picture whose form changes with voice output by said voice output unit.

11. The contents supply system as set forth in claim 9, wherein
said storage unit of said distribution server stores a plurality of electronic mail addresses of said portable-type communication terminal device and said transmission unit simultaneously transmits said contents electronic mail to said plurality of electronic mail addresses.

12. The contents supply system as set forth in claim 9, wherein
said distribution server further includes
a reception unit which receives a contents request output by said portable-type communication terminal device and an electronic mail address of the device, and wherein
said storage unit of said distribution server stores an electronic mail address received by said reception unit and said transmission unit, when said reception unit receives said contents request, transmits said contents electronic mail to an electronic mail address of a portable-type communication terminal device which has output the contents request.

13. The contents supply system as set forth in claim 9, wherein
said transmission unit of said distribution server transmits said contents electronic mail to an electronic mail address stored in said storage unit in a push-type manner.

14. The contents supply system as set forth in claim 9, wherein
said contents identification information is information which is unlikely to be used in a subject name of ordinary mail and main text of ordinary mail.

15. A contents output method executed by a portable-type communication terminal device capable of receiving electronic mail containing contents for speech synthesis which are described in text format and contents identification information indicative of the contents, comprising the steps of:
a reception step of receiving electronic mail;
a determination step of determining whether said received electronic mail contains said contents identification information or not; and
a voice output step of, when determination is made that said electronic mail contains said contents identification information, executing speech synthesis based on text describing contents of said electronic mail to output voice.

16. The contents output method as set forth in claim 15, further comprising
a step of displaying a picture whose form changes with voice output by said voice output step.

17. A contents distribution method in a distribution server which distributes, to a portable-type communication terminal device capable of receiving electronic mail containing contents for speech synthesis which are described in text format and contents identification information indicative of the contents, said contents electronic mail, comprising the steps of:
a storing step of storing an electronic mail address of said portable-type communication terminal device which receives electronic mail, determines whether said received electronic mail contains said contents identification information and when determining that said contents identification information is contained in said electronic mail, executes speech synthesis based on text describing contents of said electronic mail to output voice; and
a transmission step of transmitting contents electronic mail containing contents for speech synthesis which are described in text format and contents identification information indicative of the contents to said stored electronic mail address.

18. The contents distribution method as set forth in claim 17, wherein
said storing step includes storing a plurality of electronic mail addresses of said portable-type communication terminal device, and
said transmission step includes simultaneously transmitting said contents electronic mail to said plurality of electronic mail addresses.

19. The contents distribution method as set forth in claim 17, further comprising
a reception step of receiving a contents request output by said portable-type communication terminal device and an electronic mail address of the device, wherein
said storage step includes storing said received electronic mail address, and
said transmission step includes transmitting, when said contents request is received, said contents electronic mail to an electronic mail address of a portable-type communication terminal device which has output the contents request.

20. The contents distribution method as set forth in claim 17, wherein
said transmission step includes transmitting said contents electronic mail to said stored electronic mail address in a push-type manner.

21. The contents distribution method as set forth in claim 17, wherein
said contents identification information is information which is unlikely to be used in a subject name of ordinary mail and main text of ordinary mail.

22. A contents supply method executed by a contents supply system including a distribution server and a portable-type communication terminal device which receives electronic mail distributed by said distribution server, comprising the steps of:
a storing step by said distribution server to store an electronic mail address of said portable-type communication terminal device;
a transmission step of said distribution server to transmit contents electronic mail containing contents for speech synthesis which are described in text format and contents identification information indicative of the contents to said stored electronic mail address;
a reception step of said portable-type communication terminal device to receive electronic mail;
a determination step of said portable-type communication terminal device to determine whether said received electronic mail contains said contents identification information or not; and
a voice output step of said portable-type communication terminal device to execute speech synthesis, when said contents identification information is contained in said electronic mail, based on text describing contents of said electronic mail to output voice.

23. A contents output program executed on a portable-type communication terminal device capable of receiving electronic mail containing contents for speech synthesis which are described in text format and contents identification information indicative of the contents, comprising the functions of:
a reception function of receiving electronic mail;
a determination function of determining whether said received electronic mail contains said contents identification information; and
a voice output function of executing speech synthesis based on text describing contents of said electronic mail to output voice when determination is made that said contents identification information is contained in said electronic mail.

24. A contents distribution program executed on a distribution server which distributes, to a portable-type communication-terminal device capable of receiving electronic mail containing contents for speech synthesis which are described in text format and contents identification information indicative of the contents, said contents electronic mail, comprising the functions of:
a storing function of storing an electronic mail address of said portable-type communication terminal device which receives electronic mail, determines whether said received electronic mail contains said contents identification information and when determining that said contents identification information is contained in said electronic mail, executes speech synthesis based on text describing contents of said electronic mail to output voice; and
a transmission function of transmitting contents electronic mail containing contents for speech synthesis which are described in text format and contents identification information indicative of the contents to said stored electronic mail address.
